(19) United States
(12) Patent Application Publication
(10) Pub. No.: US 2023/0385375 A1
(43) Pub. Date: Nov. 30, 2023

(54) METHOD OF PERFORMING DISTRIBUTED MATRIX COMPUTATION USING TASK ENTANGLEMENT-BASED CODING

(71) Applicants: Seoul National University R&DB Foundation, Seoul (KR); hodooAI Lab Inc., Seoul (KR)

(72) Inventors: Jungwoo LEE, Seoul (KR); Sangwoo HONG, Gwangmyeong-si (KR); Heecheol YANG, Daejeon (KR); Sungyeob HAN, Seoul (KR)

(73) Assignees: Seoul National University R&DB Foundation, Seoul (KR); hodooAI Lab Inc., Seoul (KR)

(21) Appl. No.: 17/856,011

(22) Filed: Jul. 1, 2022

(30) Foreign Application Priority Data
May 27, 2022 (KR) 10-2022-0065328

(51) Int. Cl. G06F 17/16; G06F 7/535; G06F 7/523; G06F 7/50; H04L 67/10

(52) U.S. Cl. CPC G06F 17/16; G06F 7/535; G06F 7/523; G06F 7/50; H04L 67/10

(57) ABSTRACT

A method of performing distributed matrix computation using task entanglement-based coding as a method of processing a huge amount of matrix computation in a distributed manner in a distributed computing environment is provided. A main server encodes information to be transmitted to a plurality of edge devices for distributed matrix computation on the basis of task entanglement-based coding employing a Chebyshev polynomial, thereby reducing the amount of information to be transmitted. Also, when the number of computation results received from the edge devices becomes a recovery threshold, the main server immediately performs decoding to derive a matrix computation result.

### CROSS-REFERENCE TO RELATED APPLICATION(S)

This application claims priority from Korean Patent Application No. 10-2022-0065328, filed on May 27, 2022, in the Korean Intellectual Property Office, the disclosure of which is incorporated herein by reference in its entirety.

### BACKGROUND

### 1. Field

The following description relates to parallel computation technology, and more specifically, to a technology for performing high-dimensional matrix computation in a distributed computing environment.

### 2. Description of Related Art

Matrix multiplication is a fundamental operation in various fields such as big data analysis, machine learning, image processing, etc. In particular, most network structures of machine learning, such as a convolutional neural network (CNN), a fully convolutional network (FCN), etc., involve a huge amount of matrix multiplications. Accordingly, rapidly and efficiently performing a matrix multiplication is a serious problem influencing the performance of machine learning.

Particularly, the size of data being used in machine learning is gradually increasing, and it takes a great deal of time for one computer to process a large size of data due to the restriction of memory. To solve this problem, distributed computing and distributed machine learning for dividing data, assigning the divided data to several edge devices for computation, receiving the computation results, and processing the result data, are attracting attention these days.

According to the related art, distributed computing is mainly performed by synchronization systems. In other words, a main server assigns only one task to each edge device and then sequentially communicates with the edge devices beginning with an edge device that has finished the task. This method has a problem in that the overall computation speed is lowered due to stragglers.

The problem of stragglers is solved using a method of copying a computation task and assigning the copied computation task to several edge devices, a method of assigning a coded task in an overlapping manner on the basis of a coding theory, etc. However, these methods have a problem in that an unfinished task of a straggler is completely ignored.

Also, in distributed computing, information is likely to leak from an edge device that is polluted by a wiretapper or an attack during a communication process between a main server and the edge device.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

The following description relates to a distributed matrix multiplication method for increasing overall matrix computation speed without the problem of stragglers using a task encoding scheme based on Chebyshev polynomial codes.

The following description also relates to a distributed matrix multiplication method in which calculation results of stragglers are not ignored and partial calculation results of stragglers may be used.

The following description also relates to a distributed matrix multiplication method for reducing the amount of information that a main server transmits to edge devices using task entanglement-based coding.

Technical objects to be achieved in the present invention are not limited to those described above, and other technical objects that have not been described will be clearly understood by those of ordinary skill in the art from the following descriptions.

In one general aspect, as a method of performing distributed matrix computation using task entanglement-based coding, a method for a main server to perform distributed matrix computation using a plurality of edge devices includes a division operation, an encoding operation, a transmission operation, a reception operation, and a decoding operation.

In the division operation, the main server divides first and second matrices to be computed into m first partial matrices and n second partial matrices, respectively.

In the encoding operation, the main server encodes the m first partial matrices and the n second partial matrices into encoding matrices for each edge device on the basis of task entanglement-based coding employing a Chebyshev polynomial.

In the transmission operation, the main server transmits the encoded matrices for each edge device to the corresponding edge device.

In the reception operation, the main server receives matrix computation task results from the edge devices.

In the decoding operation, when a number of received matrix computation task results becomes a first recovery threshold, the main server decodes the received matrix computation task results to recover a computation result of the first matrix and the second matrix.

The encoding operation may include a first encoding operation and a second encoding operation.

In the first encoding operation, the main server encodes the m first partial matrices into L₂ encoding matrices for each edge device according to a determined number L (L=L₁L₂, L₁ and L₂ are coprime) of tasks on the basis of task entanglement-based coding employing a first Chebyshev polynomial with an order of L₁.

In the second encoding operation, the main server encodes the n second partial matrices into L₁ encoding matrices for each edge device on the basis of task entanglement-based coding employing a second Chebyshev polynomial with an order of L₂.

The encoding operation may further include an evaluation point selection operation.

In the evaluation point selection operation, the main server selects L₂ evaluation points to be used in the first encoding operation and L₁ evaluation points to be used in the second encoding operation for each edge device.

The main server may encode the m first partial matrices into the L₂ encoding matrices by adding a matrix, which is obtained by encoding a random matrix on the basis of task entanglement-based coding employing the first Chebyshev polynomial with an order of L₁, to encoding matrices in the first encoding operation and may encode the n second partial matrices into the L₁ encoding matrices by adding a matrix, which is obtained by encoding a random matrix on the basis of task entanglement-based coding employing the second Chebyshev polynomial with an order of L₂, to encoding matrices in the second encoding operation.

In the decoding operation, when the number of received matrix computation task results becomes a second recovery threshold, the main server may recover the computation result of the first matrix and the second matrix by decoding the received matrix computation task results.

In another general aspect, as a method of performing distributed matrix computation using task entanglement-based coding, a method of performing distributed matrix computation using a main server and a plurality of edge devices in a distributed computing environment in which the plurality of edge devices have a first matrix dataset and a second matrix dataset to be computed includes a one-hot encoding operation, a first encoding operation, a second encoding operation, a transmission operation, a first matrix encoding operation, a second matrix encoding operation, a matrix computation operation, a computation result transmission operation, a reception operation, and a decoding operation.

In the one-hot encoding operation, the main server performs one-hot encoding on indices in the corresponding datasets of a first matrix and a second matrix to be computed.

In the first encoding operation, the main server encodes a matrix obtained by performing one-hot encoding on the first matrix into a first encoding matrix for each edge device on the basis of task entanglement-based coding employing a Chebyshev polynomial.

In the second encoding operation, the main server encodes a matrix obtained by performing one-hot encoding on the second matrix into a second encoding matrix for each edge device on the basis of task entanglement-based coding employing a Chebyshev polynomial.

In the transmission operation, the main server transmits the matrices encoded for each edge device to the corresponding edge device.

In the first matrix encoding operation, the edge devices multiply all matrices of the first matrix dataset by the first encoding matrix to encode the first matrix.

In the second matrix encoding operation, the edge devices multiply all matrices of the second matrix dataset by the second encoding matrix to encode the second matrix.

In the matrix computation operation, the edge devices perform a matrix computation task on the encoded first matrix and the encoded second matrix.

In the computation result transmission operation, each edge device transmits a computation result to the main server.

In the reception operation, the main server receives the matrix computation task results from the edge devices.

In the decoding operation, when the number of received matrix computation task results becomes a first recovery threshold, the main server recovers a computation result of the first matrix and the second matrix by decoding the received matrix computation task results.

The first encoding operation may be an operation of encoding a matrix obtained by performing one-hot encoding on the first matrix into L₂ encoding matrices for each edge device according to a determined number L (L=L₁L₂, L₁ and L₂ are coprime) of tasks on the basis of task entanglement-based coding employing a first Chebyshev polynomial with an order of L₁, and the second encoding operation may be an operation of encoding a matrix obtained by performing one-hot encoding on the second matrix into L₁ encoding matrices for each edge device on the basis of task entanglement-based coding employing a second Chebyshev polynomial with an order of L₂.

The method may further include an evaluation point selection operation.

In the evaluation point selection operation, the main server may select L₂ evaluation points to be used in the first encoding operation and L₁ evaluation points to be used in the second encoding operation.

The main server may encode an encoding matrix into the L₂ encoding matrices by adding a matrix, which is obtained by encoding a random matrix on the basis of task entanglement-based coding employing the first Chebyshev polynomial with an order of L₁, to the encoding matrix in the first encoding operation and may encode an encoding matrix into the L₁ encoding matrices by adding a matrix, which is obtained by encoding a random matrix on the basis of task entanglement-based coding employing the second Chebyshev polynomial with an order of L₂, to the encoding matrix in the second encoding operation.

When the number of matrix computation task results received by the main server becomes a second recovery threshold, the main server may recover the computation result of the first matrix and the second matrix by decoding the received matrix computation task results.

Other features and aspects will be apparent from the following detailed description, the drawings, and the claims.

### BRIEF DESCRIPTION OF THE DRAWINGS

FIG. 1 is a comparison between examples of processing distributed matrix multiplication in a distributed computing environment.

FIG. 2 is a comparison between a conventional task coding scheme and a task coding scheme of the present invention.

FIG. 3 is a flowchart illustrating distributed matrix multiplication according to a first exemplary embodiment of the present invention.

FIG. 4 is a diagram illustrating the concept of distributed matrix multiplication according to a second exemplary embodiment of the present invention.

FIG. 5 is a flowchart illustrating distributed matrix multiplication according to the second exemplary embodiment of the present invention.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The above-described and additional aspects are embodied through embodiments described with reference to the accompanying drawings. It will be understood that components of each of the embodiments may be combined in various ways within one embodiment unless otherwise stated or contradicted one another. Each of blocks in a block diagram may be a representation of a physical part in some cases, but may be a logical representation of a portion of a function of one physical part or a function of a plurality of physical parts in other cases. In some cases, the block or an entry of a portion of the block may be a set of program instructions. All or some of the blocks may be implemented as hardware, software, or a combination thereof.

As used herein, A and B are matrices defined as A∈F^{a×b} and B∈F^{b×c}, respectively.

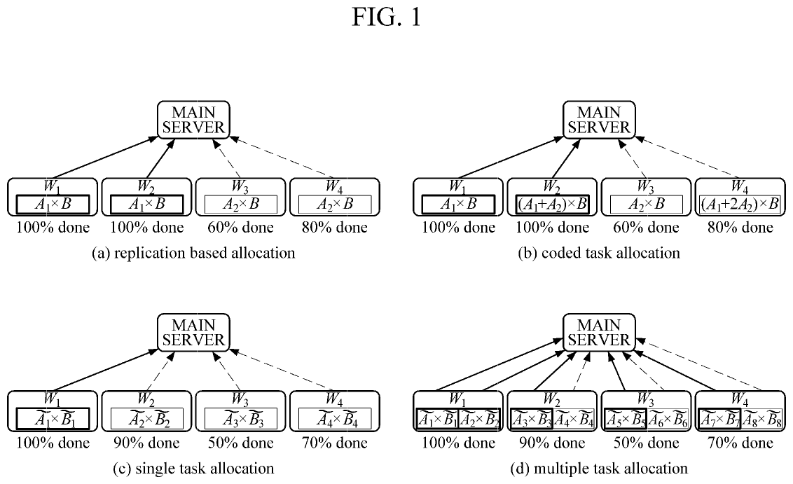

FIG. 1 is a comparison between examples of processing distributed matrix multiplication in a distributed computing environment. FIG. 1 shows various examples of processing matrix multiplication, which is a fundamental building block of machine learning and deep learning, in a distributed manner. The examples correspond to distributed matrix multiplication of C=A×B (A and B are matrices). FIG. 1 shows various examples of task assignment for solving the problem of a straggler which processes a given task much slower than other edge devices.

In FIG. 1, one main server and four workers, that is, edge devices, are shown in common.

In FIG. 1A, a computation task is copied and assigned to several workers. The main server divides a matrix A into two partial matrices A₁ and A₂ having the same size, divides an A×B task into an A₁×B task and an A₂×B task, assigns each of the divided tasks to two workers such that a computation result, a matrix C, may be obtained without delay even when one straggler occurs in each task. However, when both of two workers W₃ and W₄ in charge of the same task perform calculation slowly as shown in FIG. 1A, the main server does not obtain a final result until task results are received from the two workers, and there is still the problem of stragglers.

In FIG. 1B, the main server assigns tasks using maximum distance separable (MDS) code. When task results are received from two fast workers, the main server may decode a final result C. Accordingly, FIG. 1B allows two stragglers.

FIG. 1C is an example of encoding both input matrices A and B using a polynomial function and assigning matrix multiplication to workers as one task. In FIG. 1C, a task result of the fastest worker is used to decode a final result C.

In both FIGS. 1B and 1C, computation results of stragglers of which tasks are not finished are not used, and thus resources are wasted.

Meanwhile, FIG. 1D is an example of task assignment used in the present invention. The main server encodes two small tasks in half the size of an original task and assigns the two small tasks to each worker. In this case, as soon as one of the two assigned tasks is finished, each worker transmits the task result to the main server. The main server may decode a final result using two task results of a worker W₁ and a result of one of two tasks of workers W₂, W₃, and W₄. As a result, this approach can reduce the overall processing time in a distributed computing environment fully using computing resources.

A method of performing distributed matrix computation using task entanglement-based coding according to a first exemplary embodiment of the present invention is a method for a main server to perform distributed matrix computation using a plurality of edge devices and includes a division operation, an encoding operation, a transmission operation, a reception operation, and a decoding operation.

The main server and the edge devices are computing devices encompassing hardware and software. The computing devices include a processor and a memory which is connected to the processor and includes program instructions executable by the processor. In addition to the processor and the memory, the computing devices may further include a graphics processing unit (GPU), a storage, a display, an input device, etc. The processor executes the program instructions, and the memory is connected to the processor and stores the program instructions executable by the processor, data to be used in computation by the processor, data processed by the processor, etc.

The main server and the edge devices are connected through a network. In the division operation, the main server divides first and second matrices to be computed into m first partial matrices and n second partial matrices, respectively. When the first matrix is A and the second matrix is B, [Equation 1] may be acquired.

$$A = [ \begin{matrix}{A}_{1} \\ ⋮ \\ {A}_{m}\end{matrix} ] , B = [ \begin{matrix}{B}_{1} & … & {B}_{n}\end{matrix} ] \qquad [ Equation 1 ]$$

A₁ is a first partial matrix of A, Aₘ is an m^{th} partial matrix of A, B₁ is a first partial matrix of B, and Bₙ is an n^{th} partial matrix of B.

When A_{w} (w∈[1:m]) is defined as a partial matrix of A,

$${A}_{w} ∈ {𝔽}^{\frac{a}{m} \times b} ,$$

and when B_{z} (z∈[1:n]) is defined as a partial matrix of B,

$${B}_{z} ∈ {𝔽}^{b \times \frac{c}{n}} .$$

m and n are values determined in advance by considering the sizes of the input matrices A and B, a distributed computing environment, etc.

In the encoding operation, the main server encodes the m first partial matrices and the n second partial matrices into encoding matrices for each edge device on the basis of task entanglement-based coding employing a Chebyshev polynomial. In other words, the main server encodes the matrices A and B to be computed in the encoding operation using a Chebyshev polynomial. When the encoded matrices are Ã and \tilde{B},

$${\tilde{A}}_{i , j} ∈ {𝔽}^{\frac{a}{m} \times b} and {\tilde{B}}_{i , j} ∈ {𝔽}^{b \times \frac{c}{n}}$$

The main server encodes the matrices A and B to be computed for each edge device and encodes the matrices A and B into a plurality of encoding matrices even for one device.

According to the first exemplary embodiment of the present invention, the encoding operation may include a first encoding operation and a second encoding operation.

In the first encoding operation, the main server encodes the m first partial matrices into L₂ encoding matrices for each edge device according to a determined number L (L=L₁L₂, L₁ and L₂ are coprime) of tasks on the basis of task entanglement-based coding employing a first Chebyshev polynomial with an order of L₁.

A task assigned to an edge device for distributed matrix multiplication by the main server is a multiplication operation of encoded matrices. One task requires two encoded matrices. Therefore, when it is determined that L tasks are required for a multiplication operation between the two input matrices A and B, the main server transmits two encoded matrices for each task, that is, 2L encoded matrices, to the edge devices according to the related art.

The present invention employs a method of allowing repeated use of one encoded matrix in several tasks on the basis of task entanglement of L (L=L₁L₂, L₁ and L₂ are coprime) tasks such that L tasks can be performed as long as L₁+L₂ encoded matrices are received. Task entanglement means that tasks are entangled and several tasks are performed using the same encoded matrix. [Equation 2] below is a condition of task entanglement of matrices obtained by encoding the matrices A and B.

Ã_{t,x}=Ã_{i,x+L}_{₁}_{×(y-1)}, \tilde{B}_{i,x+L}_{×(y-i)}, i∈[1:W], ∀×∈[1: L₂], ∀y∈[1:L₁] (2)

W is the number of edge devices.

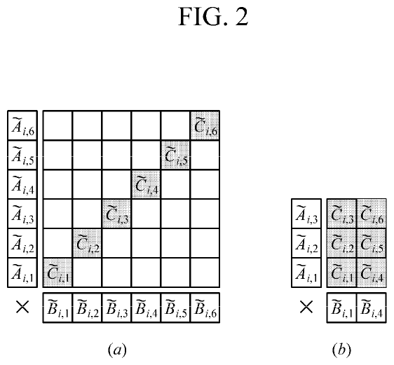

FIG. 2 is a comparison between a conventional coding scheme and a task coding scheme of the present invention. FIG. 2A shows the conventional coding scheme, and six tasks \tilde{C}_{i,1}, \tilde{C}_{i,2}, \tilde{C}_{i,3}, \tilde{C}_{i,4}, \tilde{C}_{i,5}, and \tilde{C}_{i,6} performed at an i^{th} edge device involve six encoded matrices Ã_{i,1}, Ã_{i,2}, Ã_{i,3}, Ã_{i,4}, Ã_{i,5}, and Ã_{i,6} for the matrix A and six encoded matrices \tilde{B}_{i,1}, \tilde{B}_{i,2}, \tilde{B}_{i,3}, \tilde{B}_{i,4}, \tilde{B}_{i,5}, and \tilde{B}_{i,6} for the matrix B. On the other hand, the task entanglement-based coding scheme of the present invention involves three encoded matrices Ã_{i,1}, Ã_{i,2}, and Ã_{i,3} for the matrix A and two encoded matrices \tilde{B}_{i,1} and \tilde{B}_{i,4} for the matrix B. Here, the condition of task entanglement is Ã_{i,1}=Ã_{i,4}, Ã_{i,2}=Ã_{i,5}, Ã_{i,3}=Ã_{i,6}, \tilde{B}_{i,1}=\tilde{B}_{i,2}=\tilde{B}_{i,3}, and \tilde{B}_{i,4}=\tilde{B}_{i,5}=\tilde{B}_{i,6}.

In the first encoding operation, the main server encodes a first partial matrix of the matrix A employing a Chebyshev polynomial through the encoding function p_{A}(x) of [Equation 3].

$${p}_{A} ( x ) = {\sum }_{w = 1}^{m} {A}_{w} {f ( x )}^{w - 1} , {p}_{B} ( x ) = {\sum }_{z = 1}^{n} {B}_{z} {g ( x )}^{z - 1} \qquad [ Equation 3 ]$$

f(x) is a Chebyshev polynomial with an order of L₁, and g(x) is a Chebyshev polynomial with an order of L₂.

The main server selects L evaluation points x_{i,j} (j∈[1:L]) for each edge device, finds L₂ evaluation points for a first matrix (m first partial matrices) according to the task entanglement condition of [Equation 2], and encodes the L₂ evaluation points into L₂ encoding matrices through the encoding function p_{A}.

In the second encoding operation, the main server encodes the n second partial matrices into L₁ encoding matrices for each edge device on the basis of task entanglement-based coding employing a second Chebyshev polynomial with an order of L₂.

The main server finds L₁ evaluation points for a second matrix (n second partial matrices) for each edge device according to the task entanglement condition of [Equation 2] from the same L evaluation points x_{i,j} (j∈[1:L]) as used in the first encoding operation and encodes the L₁ evaluation points into L₁ encoding matrices through an encoding function p_{B}.

According to the first exemplary embodiment of the present invention, the encoding operation may further include an evaluation point selection operation.

In the evaluation point selection operation, the main server selects L₂ evaluation points to be used in the first encoding operation and L₁ evaluation points to be used in the second encoding operation. The evaluation point selection operation is performed before encoding is performed

A Chebyshev polynomial used in task entanglement-based coding is a polynomial for which the commutative law holds, and a Chebyshev polynomial with an order of d has different real roots at (−1, 1). Using these characteristics in the evaluation point selection operation, the main server calculates L evaluation points for L tasks and then selects L₁+L₂ evaluation points according to the condition of task entanglement. A procedure for calculating an evaluation point is as follows.

f(x) is a Chebyshev polynomial with an order of L₁, and g(x) is a Chebyshev polynomial with an order of L₂.

i) An arbitrary value t between (−1, 1) is selected for the i^{th} edge device. As tᵢ, a value other than those selected by other edge devices is selected. In other words, when a≠b, tₐ≠t_{b}.

ii) \tilde{x}_{i,k}(k∈[1:L₁], the root of f(x)=tᵢ is calculated.

iii) x_{i,j,k} (j∈[1:L₂], k∈[1:L₁), the root of g(x)=\tilde{x}_{i,k}(k∈[1:L₁] is calculated. iv) x_{i,j,k} is redisposed with respect to j to satisfy f(x_{i,j,k})=\tilde{x}_{i,j}. In other words, x_{i,j,k} is redisposed to satisfy the condition of task entanglement.

The process from i) to iv) is repeated for each edge device. In the encoding operation, the main server performs encoding by inserting an x value of an evaluation point to a variable x of the encoding functions. Accordingly, the main server generates L₂ encoded matrices for the first matrix A and generates L₁ encoded matrices for the second matrix B.

In the transmission operation, the main server transmits the encoded matrices for each edge device to the corresponding edge device. Accordingly, the main server transmits L₁+L₂ encoded matrices to each edge device. While the related art involves transmitting 2L encoded matrices for L tasks, the number of pieces of transmission data is reduced to L₁+L₂ according to the present invention.

Each edge device performs matrix multiplication using encoded matrices received from the main server. In other words, the i^{th} edge device performs L tasks, computation of \tilde{c}_{i,j,k}=Ã_{i,j}×\tilde{B}_{i,k}, by multiplying an encoded matrix Ã_{i,j} and \tilde{B}_{i,k} (j∈[1:L₂], k∈[1:L₁]) received from the main server. As soon as each task is finished, the edge device transmits the computation result to the main server.

In the reception operation, the main server receives matrix computation task results from the edge devices.

In the decoding operation, when the number of received matrix computation task results becomes a first recovery threshold, the main server decodes the received matrix computation task results to recover a computation result of the first matrix and the second matrix. In other words, when as many computation results as the first recovery threshold are received from all the edge devices, the main server immediately performs decoding. Since encoding matrices are generated in the size of 1/m or 1/n from the original matrices, the computation amount of one task performed at an edge device becomes 1/mn of the original computation amount. Accordingly, the main server can recover a final target value when computation values of mn encoded matrices are acquired, and thus the first recovery threshold may be calculated as m×n.

A final computation result may be represented using multiplication of partial matrices as shown in [Equation 4].

$$c = [ \begin{matrix}{A}_{1} {B}_{1} & … & {A}_{1} {B}_{n} \\ ⋮ & ⋱ & ⋮ \\ {A}_{m} {B}_{1} & … & {A}_{m} {B}_{n}\end{matrix} ] \qquad [ Equation 4 ]$$

Therefore, the final computation result may be calculated using [Equation 5], and each coefficient matrix may be extracted using repeated divisions and the like of f(x) and g(x). Specifically, AₘBₙ may be calculated as a quotient by dividing p_{C}(x) by f(x)^{m-1}g(x)ⁿ⁻¹, and Aₘ₋₁Bₙ Bn may be calculated as a quotient by dividing the remainder by f(x)^{m-2}g(x)ⁿ⁻¹. In this way, each coefficient matrix is extracted using repeated divisions.

p_{C}(x)=p_{A}(x)×p_{B}(x)=A₁B₁+ . . . +AₘBₙf(x)^{m-1}g(x)ⁿ⁻¹ (5)

According to the first exemplary embodiment of the present invention, in the first encoding operation, the main server may add a matrix obtained by encoding a random matrix on the basis of task entanglement-based coding employing a first Chebyshev polynomial with an order of L₁ to an encoding matrix as shown in [Equation 6], thereby encoding the encoding matrix into L₂ encoding matrices. In the second encoding operation, the main server may add a matrix obtained by encoding a random matrix on the basis of task entanglement-based coding employing a second Chebyshev polynomial with an order of L₂ to the encoding matrix as shown in [Equation 6], thereby encoding the encoding matrix into L₁ encoding matrices. In other words, the main server may apply a security restriction in the first encoding operation and the second encoding operation.

$${p}_{A} ( x ) = {\sum }_{w = 1}^{m} {A}_{w} {f ( x )}^{w - 1} + {\sum }_{w = 1}^{{EL}_{2}} {Z}_{w} {f ( x )}^{m + w - 1} , \\ {p}_{B} ( x ) = {\sum }_{z = 1}^{n} {B}_{z} {g ( x )}^{z - 1} + {\sum }_{z = 1}^{{EL}_{1}} {Z}_{z} {g ( x )}^{n + z - 1} \qquad [ Equation 6 ]$$

Z_{w} and Z_{z} are random matrices, and E is the number of colluding edge devices.

As coefficients, the encoding functions employ first matrices A and B and a matrix Z in which each element has a random value. Since each element value of the matrix Z is extracted from a random distribution, the matrix Z has the largest entropy according to information theory. The encoding functions of [Equation 6] ensure complete data security in distributed computing and distributed machine learning. According to information theory, this can be proved by a zero-knowledge proof proposed by Shannon. This represents that each edge device cannot acquire any information from encoded matrices assigned for a task and may be mathematized as shown in [Equation 7].

$$I ( {\{ {\{ {\tilde{A}}_{i , j} \}}_{j = 1}^{L} \}}_{∀ i ∈ s} , {\{ {\{ {\tilde{B}}_{i , j} \}}_{j = 1}^{L} \}}_{∀ i ∈ z} ; A , B ) = 0 , \\ ∀ ε ⊂ [ 1 : W ] , \vert ε \vert = E \qquad [ Equation 7 ]$$

[Equation 7] represents that mutual information between a set of matrices Ã and \tilde{B}, which are assigned to all the edge devices for L tasks, and the original matrices A and B is 0. In other words, even when all E colluding edge devices share assigned matrices with each other and collude to infer the original matrices, according to information theory, it is never possible to obtain the original matrices. This is because a random matrix Z used in the encoding functions has greater entropy than the input matrices A and B.

In this case, when the number of received matrix computation task results becomes a second recovery threshold in the decoding operation, the main server decodes the received matrix computation task results to recover a computation result of the first matrix and the second matrix. The first recovery threshold corresponds to the same number of inner products as the original matrix multiplication. However, when a random matrix is added for encoding, the number of inner products which is approximately linearly proportional to the number of assigned tasks becomes the second recovery threshold as shown in [Equation 8], and a final result may be recovered from a computation result corresponding to the second recovery threshold.

R=(m+EL₂)(n+EL₁)≅(m+E\sqrt{L})(n+E\sqrt{L}) (8)

E is the number of edge servers which collude with each other to leak matrix information.

On the other hand, in the case of an encoding method employing a polynomial according to the related art, when a security restriction is applied, decoding involves as many inner product results as R=(m+EL)(n+EL).

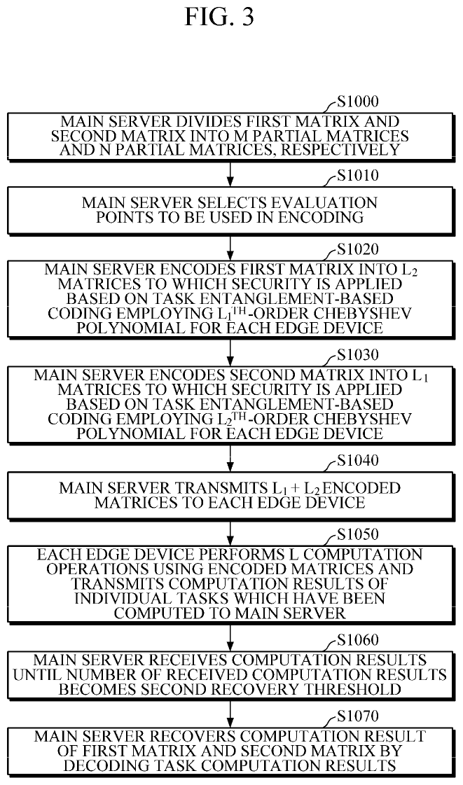

FIG. 3 is a flowchart illustrating distributed matrix multiplication according to the first exemplary embodiment of the present invention. The main server receives a first matrix and a second matrix to be computed and divides the first matrix and the second matrix into m first partial matrices and n second partial matrices, respectively (S1000).

The main server selects L₂ evaluation points to be used in a first encoding operation and L₁ evaluation points to be used in a second encoding operation for L tasks of each edge device (S1010). Here, the evaluation points satisfy the task entanglement condition of [Equation 2]. For each edge device, the main server encodes the first matrix into L₂ encoding matrices to which security is applied on the basis of task entanglement-based coding employing a first Chebyshev polynomial with an order of L₁ as shown in [Equation 6] (S1020) and encodes the second matrix into L₁ encoding matrices to which security is applied on the basis of task entanglement-based coding employing a second Chebyshev polynomial with an order of L₂ as shown in [Equation 6] (S1030). The main server transmits L₁+L₂ matrices encoded for each edge device to the corresponding edge device (S1040). Each edge device performs L computation tasks using the received encoded matrices. As soon as each individual computation task is finished, each edge device transmits the computation result to the main server (S1050). The main server receives matrix computation task results from edge devices (S1060). When the number of received matrix computation task results becomes a second recovery threshold, the main server recovers a computation result of the first matrix and the second matrix by decoding the received matrix computation task results (S1070).

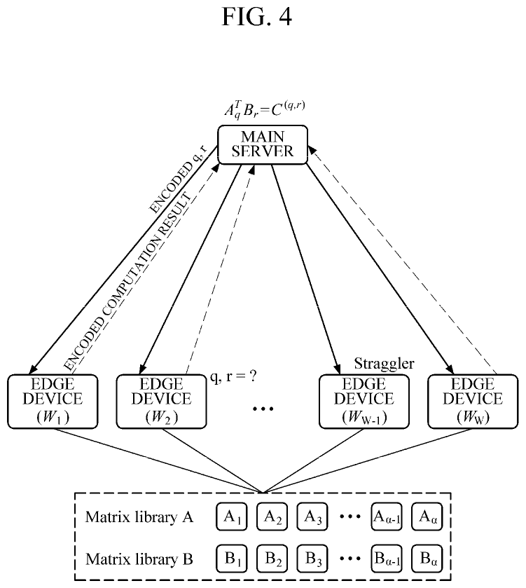

FIG. 4 is a diagram illustrating the concept of distributed matrix multiplication according to a second exemplary embodiment of the present invention. The example of

FIG. 4 is a distributed matrix multiplication method that is applicable when edge devices may access a matrix dataset in which matrices to be computed are stored, that is, matrix libraries, or store matrix datasets on their own. In other words, in the second exemplary embodiment, the main server does not transmit data to be computed to each edge device for matrix computation, but edge devices may access matrix datasets. Accordingly, indices in matrix datasets to be computed are transmitted so that distributed matrix computation may be performed.

When edge devices may access matrix libraries, the main server may transmit a request (query) to perform matrix computation to the edge devices. In this case, the edge devices perform matrix computation according to the request such that distributed computing is performed. The edge devices may infer which data is to be computed by the main server from the received request. When the main server requests matrix computation by simply transmitting indices in a dataset of matrix data used in computation, the edge devices may infer information requested by the main server very easily. The edge devices may find a computation preference of the main server, and private information may leak. Accordingly, when desired matrix computation is requested by encoding index information in a desired matrix dataset for private information protection, the private information of the main server can be protected. Here, a constraint on private information protection is represented by [Equation 9] below.

I(,r;{Q_{A}^{(q)}(x_{i,j})}ⱼ₌₁^{L}, {Q_{B}^{(r)}(x_{i,j})}ⱼ₌₁^{L}, A, B)=0 (9)

A and B are matrix libraries, and q and r are an A matrix library index and a B matrix library index, respectively. I(x;y) is a function representing the information amount of x that may be inferred when y is known. The above equation means that no information on q or r is obtained even when {Q_{A}^{(q)}(x_{i,j})}ⱼ₌₁^{L}, {Q_{B}^{(r)}(x_{i,j})}ⱼ₌₁^{L}, A, B is known.

A distributed matrix computation method employing task entanglement-based coding according to the second exemplary embodiment is a method of performing distributed matrix computation using a main server and a plurality of edge devices in a distributed computing environment in which the plurality of edge devices have a first matrix dataset and a second matrix dataset to be computed. The distributed matrix computation method includes a one-hot encoding operation, a first encoding operation, a second encoding operation, a transmission operation, a first matrix encoding operation, a second matrix encoding operation, a matrix computation operation, a computation result transmission operation, a reception operation, and a decoding operation.

In the one-hot encoding operation, the main server performs one-hot encoding on indices in corresponding datasets of a first matrix and a second matrix to be computed.

Since the indices are scalar values, the main server performs one-hot encoding on the indices so that the indices may become suitable for use in matrix computation.

In the first encoding operation, the main server encodes a matrix obtained by performing one-hot encoding on the first matrix into a first encoding matrix for each edge device on the basis of task entanglement-based coding employing a Chebyshev polynomial. In other words, the main server encodes a matrix obtained by performing one-hot encoding on indices in a first matrix dataset of the first matrix to be computed into Q_{A}^{(q)}(x_{i,j}) as shown in [Equation 10] below. In the second encoding operation, the main server encodes a matrix obtained by performing one-hot encoding on the second matrix into a second encoding matrix for each edge device on the basis of task entanglement-based coding employing a Chebyshev polynomial. In other words, the main server encodes a matrix obtained by performing one-hot encoding on indices in a second matrix dataset of the second matrix to be computed into Q_{B}^{(r)}(x_{i,j}) as shown in [Equation 10] below.

$${Q}_{A}^{( q )} ( {x}_{i , j} ) = [ \begin{matrix}{θ}_{A} {f}^{{c}_{1}} ( {x}_{i , j} ) \\ ⋮ \\ {θ}_{A} {f}^{{c}_{s} + m - 1} ( {x}_{i , j} )\end{matrix} ] , \\ {Q}_{B}^{( r )} ( {x}_{i , j} ) = [ \begin{matrix}{θ}_{B} {g}^{{c}_{2}} ( {x}_{i , j} ) \\ ⋮ \\ {θ}_{B} {g}^{{c}_{2} + n - 1} ( {x}_{i , j} )\end{matrix} ] \qquad [ Equation 10 ]$$

c₁ and c₂ are arbitrary constants which are set according to each situation, and m and n are the number of parts into which the first matrix will be divided and the number of parts into which the second matrix will be divided, respectively. θ_{A} and θ_{B} are one-hot encoded matrices. f(x) is a Chebyshev polynomial with an order of L₁, and g(x) is a Chebyshev polynomial with an order of L₂.

According to the second exemplary embodiment of the present invention, the first encoding operation is an operation of encoding the matrix obtained by performing one-hot encoding on the first matrix into L₂ encoding matrices for each edge device according to a determined number L (L=L₁L₂, L₁ and L₂ are coprime) of tasks on the basis of task entanglement-based coding employing a first Chebyshev polynomial with an order of L₁, and the second encoding operation is an operation of encoding the matrix obtained by performing one-hot encoding on the second matrix into L₁ encoding matrices for each edge device on the basis of task entanglement-based coding employing a second Chebyshev polynomial with an order of L₂. [Equation 11] below is a task entanglement condition of a matrix obtained by encoding a matrix obtained by performing one-hot encoding on indices in matrix libraries of matrices A and B.

Q_{A}^{(q)}(x_{i,j})=Q_{A}^{(q)}(x_{i,j+L}_{₂}_{×(t-1)}), Q_{B}^{(r)}(x_{i,j})=Q_{B}^{(r)}(x_{i,j+L}_{₂}_{×(t-1)}), i∈[1:W], ∀_{S}∈[1:L₂], ∀ₜ∈[1:L₁] (11)

W is the number of edge devices.

The main server selects L evaluation points x_{i,j} (j∈[1:L]) for each edge device, finds evaluation points of the L₂ matrices obtained by performing one-hot encoding on the first matrix according to the task entanglement condition, and encodes the evaluation points into Q_{A}^{(q)}(x_{i,j}) as shown in [Equation 10]. Also, the main server finds evaluation points of the L₁ matrices obtained by performing one-hot encoding on the second matrix according to the task entanglement condition at the same L evaluation points x_{i,j} (j∈[1:L]) and encodes the L₁ evaluation points into as shown in [Equation 1].

According to the second exemplary embodiment of the present invention, the encoding operation may further include an evaluation point selection operation. In the evaluation point selection operation, the main server selects L₂ evaluation points to be used in the first encoding operation and L₁ evaluation points to be used in the second encoding operation for each edge device. The evaluation point selection operation is performed before encoding is performed.

In the transmission operation, the main server transmits the matrices encoded for each edge device to the corresponding edge device. Accordingly, the main server transmits L₁+L₂ encoded matrices to each edge device. While the related art involves transmitting 2L encoded matrices for L tasks, the number of pieces of transmission data is reduced to L₁+L₂ according to the present invention.

In the first matrix encoding operation, the edge devices multiply all matrices of the first matrix dataset by the first encoding matrix as shown in [Equation 12] to encode the first matrix. Each edge device does not know which matrix of the first matrix dataset is used in the computation. Like in the first exemplary embodiment, the first matrix is divided into m parts in the second exemplary embodiment. In other words, each of the matrices in the first matrix dataset is divided into m parts, and then encoding is performed.

$${\tilde{A}}_{i , j} = {p}_{A} ( {x}_{i , j} ) = {\sum }_{k = 1}^{m} ( [ \begin{matrix}{A}_{1 , k}^{T} & … & {A}_{a , k}^{T}\end{matrix} ] \times ( {{Q}_{A , k}^{( q )} ( {x}_{i , j} )}^{T} ⊗ {l}_{b \times b} ) ) \qquad [ Equation 12 ]$$

α is the number of A matrices in the first matrix dataset. A_{1,k}, . . . , and A_{α,k} correspond to a k^{th} partial matrix of the matrices in the first matrix dataset, and Q_{A,k}^{(q)}(x_{i,j}) is a k^{th} partial matrix of Q_{A}^{(q)}(x_{i,j}).

In the second matrix encoding operation, the edge devices multiply all matrices of the second matrix dataset by the second encoding matrix as shown in [Equation 13] to encode the second matrix. Likewise, each edge device does not know which matrix of the second matrix dataset is used in the computation. Like in the first exemplary embodiment, the second matrix is divided into n parts in the second exemplary embodiment. In other words, each of the matrices in the second matrix dataset is divided into n parts, and then encoding is performed.

$${\tilde{B}}_{i , j} = {p}_{B} ( {x}_{i , j} ) = {\sum }_{k = 1}^{n} ( [ \begin{matrix}{B}_{1 , k}^{T} & … & {B}_{β , k}^{T}\end{matrix} ] \times ( {{Q}_{B , k}^{( r )} ( {x}_{i , j} )}^{T} ⊗ {l}_{\frac{c}{n} \times \frac{c}{n}} ) ) \qquad [ Equation 13 ]$$

β is the number of B matrices in the second matrix dataset. B_{1,k}, . . . , and B_{β,k} correspond to a k^{th} partial matrix of all the matrices in the second matrix dataset, and Q_{B,k}^{(r)}(x_{i,j}) is a k^{th} partial matrix of Q_{B}^{(r)}(x_{i,j}).

In the matrix computation operation, the edge devices perform a matrix computation task on the encoded first matrix and the encoded second matrix.

In the computation result transmission operation, each edge device transmits a computation result to the main server.

In the reception operation, the main server receives the matrix computation task results from the edge devices.

In the decoding operation, when the number of received matrix computation task results becomes a first recovery threshold, the main server recovers a computation result of the first matrix and the second matrix by decoding the received matrix computation task results. In other words, when as many computation results as the first recovery threshold are received from all the edge devices, the main server immediately performs decoding. Since encoding matrices are generated in the size of 1/m or 1/n from the original matrices, the computation amount of one task performed at an edge device becomes 1/mn of the original computation amount. Accordingly, the main server can recover a final target value when computation values of mn encoded matrices are acquired. Consequently, the first recovery threshold may be calculated as m×n.

A final computation result may be represented using multiplication of partial matrices as shown in [Equation 4].

Therefore, the final computation result may be calculated using [Equation 14], and each coefficient matrix may be extracted using repeated divisions and the like of f(x) and g(x). Specifically, AₘBₙ may be calculated as a quotient by dividing p_{C}(x) by

$${f ( x )}^{{L}_{2} ( \frac{n - 1}{{L}_{1}} + T ) + m - 1} {g ( x )}^{{L}_{1} ( \frac{m - 1}{{L}_{2}} + T ) + n - 1} .$$

In this way, each coefficient matrix may be extracted using repeated divisions.

$${p}_{C} ( x ) = {p}_{A} ( x ) \times {p}_{B} ( x ) = {\sum }_{i = 1}^{m} {\sum }_{j = 1}^{n} {A}_{q , i} {B}_{r , j} {f ( x )}^{{L}_{2} ( \frac{n - 1}{{L}_{1}} + T ) + i - 1} {g ( x )}^{{L}_{1} ( \frac{m - 1}{{L}_{2}} + T ) + j - 1} + {\sum }_{i = 1}^{m} {\sum }_{k = 1}^{{L}_{i} T} {A}_{q , i} {ζ}_{B , k} {f ( x )}^{{L}_{2} ( \frac{n - 1}{{L}_{2}} + T ) + i - 1} {g ( x )}^{k - 1} + {\sum }_{j = 1}^{n} {\sum }_{i = 1}^{{L}_{2} T} {B}_{r , j} {ζ}_{A , i} {f ( x )}^{l - 1} {g ( x )}^{{L}_{2} ( \frac{m - 1}{{L}_{2}} + T ) + j - 1} + {\sum }_{k = 1}^{{L}_{1} T} {\sum }_{i = 1}^{{L}_{2} T} {ζ}_{A , i} {ζ}_{B , k} {f ( x )}^{i - 1} {g ( x )}^{k - 1} \qquad [ Equation 14 ]$$

$$Here , {ζ}_{A , i} = {\sum }_{k = 1}^{m} ( [ \begin{matrix}{A}_{1 , k}^{T} & … & {A}_{α , k}^{T}\end{matrix} ] \times ( {z}_{k , i}^{T} ⊗ {I}_{b \times b} ) and \\ {ζ}_{B , k} = {\sum }_{t = 1}^{n} ( ⌊ \begin{matrix}{B}_{1 , i} & … & {B}_{β , i}\end{matrix} ⌋ \times ( {z}_{m + i , k}^{T} ⊗ {l}_{\frac{c}{n} \times \frac{c}{n}} ) ) .$$

According to the second exemplary embodiment of the present invention, the main server may encode an encoding matrix into the L₂ encoding matrices by adding a matrix obtained by encoding a random matrix on the basis of task entanglement-based coding employing the first Chebyshev polynomial with an order of L₁ to the encoding matrix in the first encoding operation as shown in [Equation 15] and may encode an encoding matrix into the L₁ encoding matrices by adding a matrix obtained by encoding a random matrix on the basis of task entanglement-based coding employing the second Chebyshev polynomial with an order of L₂, to the encoding matrix in the second encoding operation as shown in [Equation 15]. In other words, the main server may apply a security restriction in the first encoding operation and the second encoding operation.

$${Q}_{A}^{( q )} ( {x}_{i , j} ) = [ \begin{matrix}{\sum }_{i = 1}^{{L}_{2}} {Z}_{i , l} {f}^{i - 1} ( {x}_{i , j} ) + {θ}_{A} {f}^{{c}_{1} + {L}_{2}} ( {x}_{i , j} ) \\ ⋮ \\ {\sum }_{i = 1}^{{L}_{2}} {Z}_{m , l} {f}^{i - 1} ( {x}_{i , j} ) + {θ}_{A} {f}^{{c}_{1} + {L}_{2} + m - 1} ( {x}_{i , j} )\end{matrix} ] \qquad [ Equation 15 ]$$

$${Q}_{B}^{( r )} ( {x}_{i , j} ) = [ \begin{matrix}{\sum }_{i = 1}^{{L}_{1}} {Z}_{m + 1 , l} {g}^{i - 1} ( {x}_{i , j} ) + {θ}_{B} {g}^{{c}_{2} + {L}_{2}} ( {x}_{i , j} ) \\ ⋮ \\ {\sum }_{i = 1}^{{L}_{1}} {Z}_{m + n , l} {g}^{i - 1} ( {x}_{i , j} ) + {θ}_{B} {f}^{{c}_{2} + {L}_{2} + n - 1} ( {x}_{i , j} )\end{matrix} ]$$

Z is a random matrix.

As coefficients, the encoding functions employ a matrix Z in which each element has a random value. Since each element value of the matrix Z is extracted from a random distribution, the matrix Z has the largest entropy according to information theory. The encoding functions of [Equation 15] ensure complete data security in distributed computing and distributed machine learning. According to information theory, this can be proved by a zero-knowledge proof proposed by Shannon. This represents that each edge device cannot acquire any information from encoded matrices assigned for a task and may be mathematized as shown in [Equation 7].

In this case, when the number of received matrix computation task results becomes a second recovery threshold in the decoding operation, the main server decodes the received matrix computation task results to recover a computation result of the first matrix and the second matrix. The first recovery threshold corresponds to the same number of inner products as the original matrix multiplication. However, when a random matrix is added for encoding, the number of inner products which is approximately linearly proportional to the number of assigned tasks becomes the second recovery threshold as shown in [Equation 16], and a final result may be recovered from a computation result corresponding to the second recovery threshold.

R=2L₁L₂T+2(m−1)L₁+2(n−1)L₂+1 (16)

On the other hand, in the case of an encoding method employing a polynomial according to the related art, when a security restriction is applied, decoding involves as many inner product results as R=(m+EL)(n+EL).

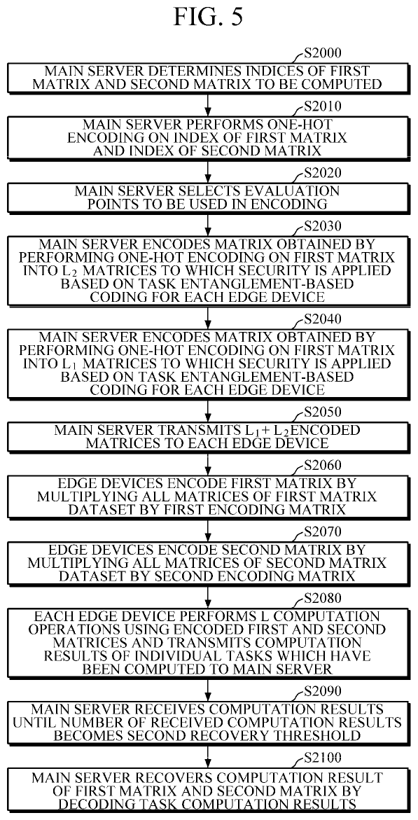

FIG. 5 is a flowchart illustrating distributed matrix multiplication according to the second exemplary embodiment of the present invention. The main server determines indices in a first matrix dataset and a second matrix dataset of a first matrix and a second matrix to be computed (S2000). Also, the main server determines m and n that are the number of parts into which the first matrix will be divided and the number of parts into which the second matrix will be divided, respectively. The main server performs one-hot encoding on the determined indices (S2010). For L tasks of each edge device, the main server selects L₂ evaluation points to be used in encoding one-hot encoded matrices with respect to the first matrix and L₁ evaluation points to be used in encoding one-hot encoded matrices with respect to the second matrix (S2020). Here, the evaluation points satisfy a task entanglement condition. For each edge device, the main server encodes a matrix obtained by performing one-hot encoding on the first matrix into L₂ encoding matrices to which security is applied on the basis of task entanglement-based coding employing a first Chebyshev polynomial with an order of L₁ as shown in [Equation 13] (S2030) and encodes the second matrix into L₁ encoding matrices to which security is applied on the basis of task entanglement-based coding employing a second Chebyshev polynomial with an order of L₂ as shown in [Equation 13] (S2040). The main server transmits L₁+L₂ matrices encoded for each edge device to the corresponding edge device (S2050). The edge devices encode the first matrix by multiplying all matrices in the first matrix dataset by a first encoding matrix as shown in [Equation 11] (S2060), encode the second matrix by multiplying all matrices in the second matrix dataset by a second encoding matrix as shown in [Equation 12] (S2070), and then perform matrix computation tasks on the encoded first matrix and the encoded second matrix. As soon as each individual computation task is finished, each edge device transmits the computation result to the main server (S2080). The main server receives matrix computation task results from edge devices (S2090). When the number of received matrix computation task results becomes a second recovery threshold, the main server recovers a computation result of the first matrix and the second matrix by decoding the received matrix computation task results (S2100).

The present invention can increase overall matrix computation speed without the problem of stragglers using a task encoding scheme based on Chebyshev polynomial codes.

Also, according to the present invention, calculation results of stragglers are not ignored, and partial calculation results of stragglers can be used.

Further, according to the present invention, it is possible to reduce the amount of information that a main server transmits to edge devices using task entanglement-based coding.

While the present invention has been described with reference to the embodiments and drawings, the present invention is not limited thereto and should be construed as including various modifications that can be clearly derived from the embodiments by those of ordinary skill in the art. The claims are intended to encompass such modifications.

What is claimed is:

1. A method for a main server to perform distributed matrix computation using plurality of edge devices, the method comprising:
a division operation of dividing first and second matrices to be computed into m first partial matrices and n second partial matrices, respectively;
an encoding operation of encoding the m first partial matrices and the n second partial matrices into encoding matrices for each edge device on the basis of task entanglement-based coding employing a Chebyshev polynomial;
a transmission operation of transmitting the encoded matrices for each edge device to the corresponding edge device;
a reception operation of receiving matrix computation task results from the edge devices; and
a decoding operation of, when a number of received matrix computation task results becomes a first recovery threshold, decoding the received matrix computation task results to recover a computation result of the first matrix and the second matrix.

2. The method of claim 1, wherein the encoding operation comprises:
a first encoding operation of encoding the m first partial matrices into L₂ encoding matrices for each edge device according to a determined number L (L=L₁L₂, L₁ and L₂ are coprime) of tasks on the basis of task entanglement-based coding employing a first Chebyshev polynomial with an order of L₁; and
a second encoding operation of encoding the n second partial matrices into L₁ encoding matrices for each edge device on the basis of task entanglement-based coding employing a second Chebyshev polynomial with an order of L₂.

3. The method of claim 2, wherein the encoding operation further comprises an evaluation point selection operation of selecting L₂ evaluation points to be used in the first encoding operation and L₁ evaluation points to be used in the second encoding operation.

4. The method of claim 3, wherein the first encoding operation comprises encoding the m first partial matrices into the L₂ encoding matrices by adding a matrix obtained by encoding a random matrix on the basis of task entanglement-based coding employing the first Chebyshev polynomial with an order of L₁ to encoding matrices; and
the second encoding operation comprises encoding the n second partial matrices into the L₁ encoding matrices by adding a matrix obtained by encoding a random matrix on the basis of task entanglement-based coding employing the second Chebyshev polynomial with an order of L₂ to encoding matrices.

5. The method of claim 4, wherein the decoding operation comprises, when the number of received matrix computation task results becomes a second recovery threshold, decoding the received matrix computation task results to recover the computation result of the first matrix and the second matrix.

6. A method of performing distributed matrix computation using a main server and plurality of edge devices in a distributed computing environment in which the plurality of edge devices have a first matrix dataset and a second matrix dataset to be computed, the method comprising:
a one-hot encoding operation in which the main server performs one-hot encoding on indices in the corresponding datasets of a first matrix and a second matrix to be computed;
a first encoding operation in which the main server encodes a matrix obtained by performing one-hot encoding on the first matrix into a first encoding matrix for each edge device on the basis of task entanglement-based coding employing a Chebyshev polynomial;
a second encoding operation in which the main server encodes a matrix obtained by performing one-hot encoding on the second matrix into a second encoding matrix for each edge device on the basis of task entanglement-based coding employing a Chebyshev polynomial;
a transmission operation in which the main server transmits the matrices encoded for each edge device to the corresponding edge device;
a first matrix encoding operation in which the edge devices multiply all matrices of the first matrix dataset by the first encoding matrix to encode the first matrix;
a second matrix encoding operation in which the edge devices multiply all matrices of the second matrix dataset by the second encoding matrix to encode the second matrix;
a matrix computation operation in which the edge devices perform a matrix computation task on the encoded first matrix and the encoded second matrix;
a computation result transmission operation in which each edge device transmits a computation result to the main server;
a reception operation in which the main server receives the matrix computation task results from the edge devices; and
a decoding operation in which, when a number of received matrix computation task results becomes a first recovery threshold, the main server recovers a computation result of the first matrix and the second matrix by decoding the received matrix computation task results.

7. The method of claim 6, wherein the first encoding operation is an operation of encoding a matrix obtained by performing one-hot encoding on the first matrix into L₂ encoding matrices for each edge device according to a determined number L (L=L₁L₂, L₁ and L₂ are coprime) of tasks on the basis of task entanglement-based coding employing a first Chebyshev polynomial with an order of L₁, and
the second encoding operation is an operation of encoding a matrix obtained by performing one-hot encoding on the second matrix into L₁ encoding matrices for each edge device on the basis of task entanglement-based coding employing a second Chebyshev polynomial with an order of L₂.

8. The method of claim 7, further comprising an evaluation point selection operation in which the main server selects L₂ evaluation points to be used in the first encoding operation and L₁ evaluation points to be used in the second encoding operation.

9. The method of claim 8, wherein, in the first encoding operation, the main server encodes an encoding matrix into the L₂ encoding matrices by adding a matrix obtained by encoding a random matrix on the basis of task entanglement-based coding employing the first Chebyshev polynomial with an order of L₁ to the encoding matrix, and
in the second encoding operation, the main server encodes an encoding matrix into the L₁ encoding matrices by adding a matrix obtained by encoding a random matrix on the basis of task entanglement-based coding employing the second Chebyshev polynomial with an order of L₂ to the encoding matrix.

10. The method of claim 9, wherein the decoding operation comprises decoding the received matrix computation task results to recover the computation result of the first matrix and the second matrix when the number of matrix computation task results received by the main server becomes a second recovery threshold.
